(19) United States
(12) Patent Application Publication
(10) Pub. No.: US 2008/0278493 A1
(43) Pub. Date: Nov. 13, 2008

(54) METROLOGY METHODS

(75) Inventor: Howard E. Zion, Fairport, NY (US)

Correspondence Address: Stephen B. Salai, Esq.;Harter, Secrest & Emery LLP, 1600 Bausch & Lomb Place, Rochester, NY, 14604-2711, US

(73) Assignee: TRANSCAT, INC., Rochester, NY (US)

(21) Appl. No.: 11/747,352

(22) Filed: May 11, 2007

(51) Int. Cl. G06T 11/20; G06F 17/18

(52) U.S. Cl. 345/440; 702/181

(57) ABSTRACT

A metrology method of displaying results to a user includes graphically representing a target calibration amount and a tolerance associated with the target calibration on a graph, obtaining a reported reading of an instrument to be tested, and graphically representing the reported reading on the graph with an uncertainty associated with the reported reading. The method also includes display a probability of compliance of the reported reading to the target calibration amount and associated tolerance.

### BACKGROUND OF THE INVENTION

1. Field of the Invention

The present invention relates generally to metrology methods. More specifically, the present invention relates to methods of measuring and reporting test data and uncertainties related to the test data.

2. Description of the Related Art

In most industries, it is inherently necessary to inspect, evaluate, validate, and otherwise measure various manufactured products and processes. Specifically, many companies employ quality control or quality assurance individuals whose sole job is to confirm that the processes and/or products of the company conform to pre-established specifications. Such conformity is necessary to ensure that work product provided to customers is functional and reliable, for example.

Depending upon the industry, the aforementioned quality control specialists may use any of a number of techniques or instrumentalities to take measurements in furtherance of their day-to-day tasks. In the machine design industry, for example, calipers or the like are used to ensure that a manufactured part of a machine is within the tolerances specified by the mechanical designer, so the part will seamlessly operate in the overall machine. Examples like this abound in almost every industry.

As is well understood in the field of metrology, however, all measurements have some uncertainty associated therewith, and depending upon the precision required by the application, this uncertainty may play an important role in determining whether a part or process is suitable for use, must be further inspected, of must be discarded. More specifically, the field of metrology recognizes that many sources of error are inherent in any measurement (and with most standards). Understanding and quantifying these sources of error are crucial for companies to assess the risk that their product or system may not be suitable for its intended use and the risk that the consumer thus faces by using the product or system.

To date, many metrology methods have been used across many industries in an effort to quantify risks associated in production methods and produced products. However, there is a need in the art for a method and tool that enables companies to make increasingly informed decisions about the accuracy of their methods and products. Moreover, there is a need in the art for a tool that provides a user with more complete information about measurements made using conventional instrumentalities. There also is a need in the art for a method of and apparatus for presenting meaningful relationships between instrument readings, any tolerances associated with such readings, and the uncertainty surrounding the measurements.

### SUMMARY OF THE INVENTION

The present invention addresses the foregoing needs by providing metrology methods and methods of providing graphical representations to assist an instrument user in accurately determining the risk of a reported reading of the instrument.

In one aspect of the invention, a metrology method features a step of determining a probability of compliance to a specification of a measured value based on the measured value, an associated uncertainty of the measured value and a predetermined target value.

In accordance with a presently preferred embodiment of the invention, the metrology method further includes steps of displaying the probability of compliance on a graph and of graphically displaying on the graph the measured value, the associated uncertainty of the measured value, the predetermined target value, and a tolerance associated with the predetermined target value.

In another preferred aspect of the invention, a method of displaying results to a user includes the steps of graphically representing a target calibration amount and a tolerance associated with the target calibration on a graph and obtaining a reported reading of an instrument to be tested. The method further includes representing the reported reading on the graph with an uncertainty associated with the reported reading and displaying a probability of compliance of the reported reading to the target calibration amount and associated tolerance.

In yet another preferred aspect of the invention, a method of graphing measurements includes an assigning step, a comparing step, and an identifying step. In the assigning step, a two-dimensional graphic is assigned to a measured value. In the comparing step, the two-dimensional graphic is compared to a specification having predetermined upper and lower tolerances. In the identifying step, a probability of compliance of the measured value to the specification is identified.

In a still further aspect of the present invention, a method of displaying results to a user includes providing on a graph a target measurement and upper and lower tolerances of the target measurement. The method further includes graphically representing on the graph a reported reading of a tested instrument and graphically displaying a measurement uncertainty associated with the reported reading. The method also features determining and displaying on the graph a probability of compliance of the reported reading to the target measurement value and tolerances associated with the target measurement value.

A better understanding of these and other aspects and features of the present invention may be had with reference to the attached figures and following description, in which the present invention is illustrated and described.

### BRIEF DESCRIPTION OF THE DRAWING FIGURES

FIGS. 1-6 are graphical representations illustrating calibrations of a signal generator according to an embodiment of the invention.

FIG. 7 is a normal probability density function of a value measured according to a preferred embodiment of the invention, and which represents the uncertainty of the measured value

FIGS. 8-11 are screen shots of a graphical display tool according to an embodiment of the invention of illustrating measured values obtained during calibration of a signal generator.

FIG. 12 is a chart formulated according to another preferred embodiment of the invention.

FIGS. 13-15 are screen shots of a graphical display tool according to preferred embodiments of the invention illustrating measured values obtained during calibration of a signal generator.

FIGS. 16-19 are screen shots of a graphical display tool according to additional preferred embodiments of the invention.

### DETAILED DESCRIPTION OF THE INVENTION

Preferred embodiments of the invention now will be described with reference to the figures.

As described in more detail above, and as is generally understood in the metrology field, every measurement has some associated error. As is conventionally accepted in the field, a test accuracy ratio can be calculated for each individual measurement performed during a calibration and is defined as a comparison of the accuracy of a standard to the accuracy of an instrument to be calibrated. However, advancements within the field have led to the understanding that the accuracy of a standard is not the only component of uncertainty in a measurement—other sources of error exist. The more sources of error that are considered and quantified (either through actual measurement or accurate estimation) throughout the entire chain of traceability (from the National Measurement Institution through calibration labs and production processes), the more thoroughly the risk is understood. All of these errors in the chain of traceability must be considered in the estimation of uncertainty of measurement in order to fully reveal the risk associated with product measurements. If only the accuracy of the standard is considered, then the total risk has not been evaluated.

Only by quantifying and combining all of these potential sources of error can an accurate and complete estimate of the uncertainty of a measurement be derived. More specifically, the accuracy of the standard is a concept that takes into account a manufacturer's specification. However, the uncertainty of a measurement is derived from an uncertainty budget. This budget includes the accuracy of the standard as one component, as well as other components representing errors that should not be ignored. Thus, while conventional wisdom has looked at the test accuracy ratio, which is the ratio of the accuracy of a given instrument, or a unit under test (UUT), to the accuracy of the standard, it is more truthful to look at the test uncertainty ratio, which is the ratio of the accuracy of the unit under test to the uncertainty of the measurement.

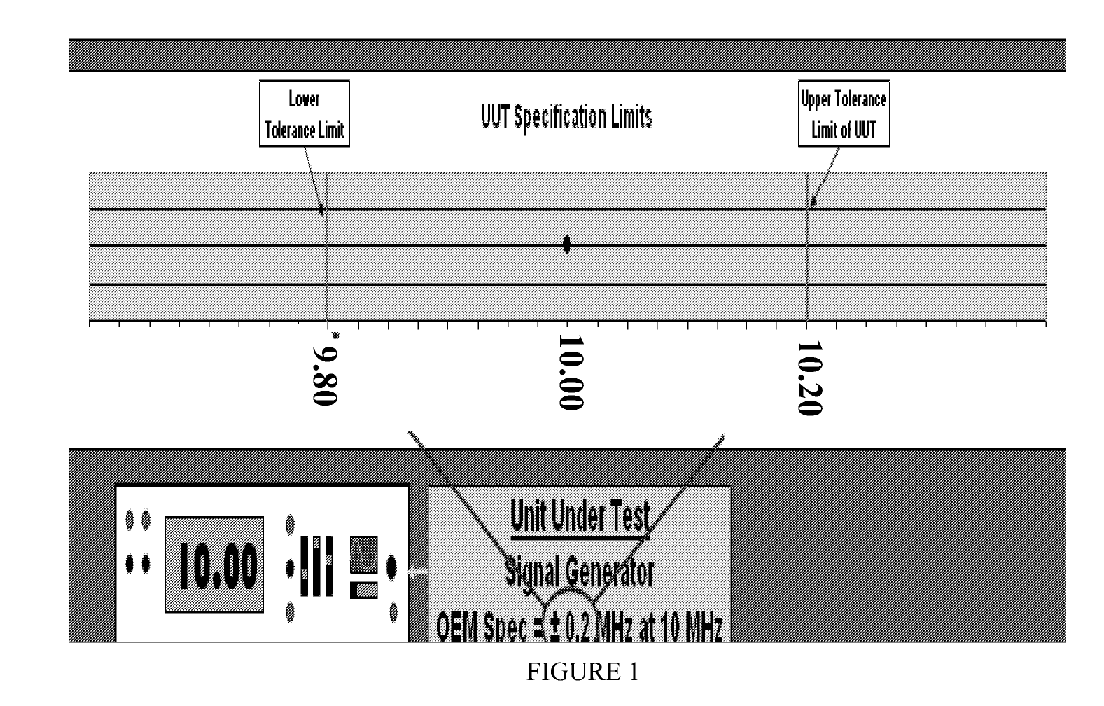

A preferred embodiment of the invention will be described with particular reference to an example in which a signal generator is the unit under test (UUT) and is to be calibrated at 10 MHz. According to the specification provided by the original equipment manufacturer (OEM) the frequency accuracy at 10 MHz is ±0.2 MHz. Thus, an upper tolerance limit for the signal generator is 10.2 MHz and a lower tolerance limit for the signal generator is 9.8 MHz. This concept is illustrated graphically in FIG. 1.

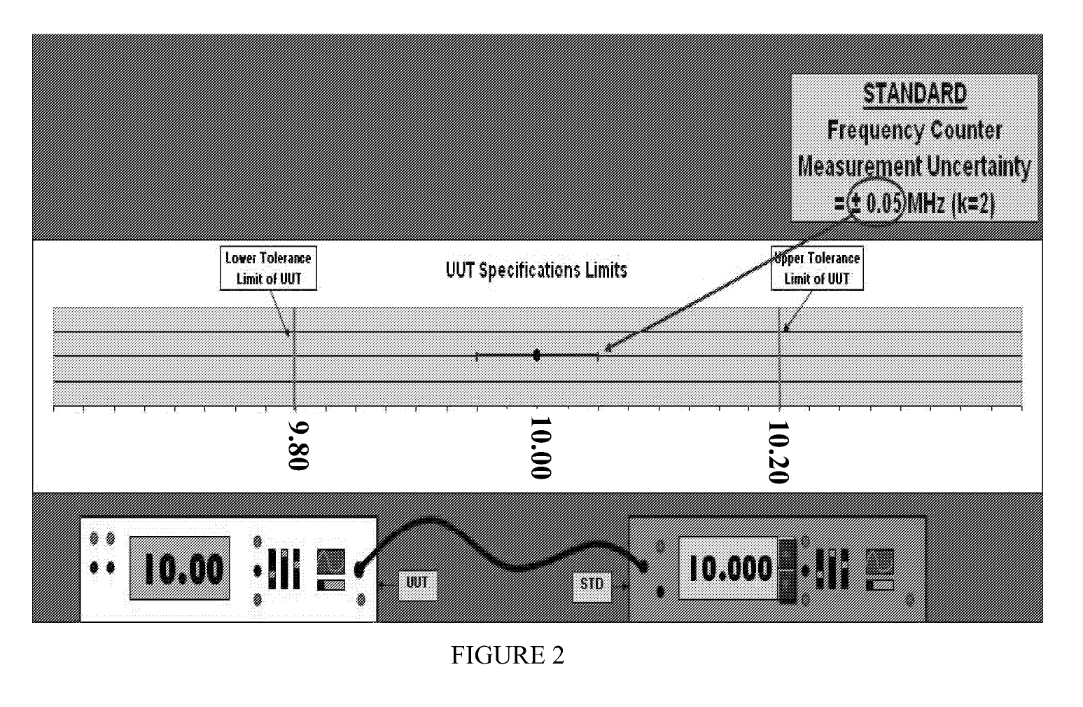

In the graphic of FIG. 1, the point at 10.000 MHz represents the measured value of the signal generator, or unit under test. In this example, the measured value is 10.000 MHz, or nominal. However, FIG. 1 does not take into account uncertainties different than those included in the standard. More specifically, it does not take into account the uncertainty of the measurement, which, as described in more detail above, is calculated from an uncertainty budget. The individual components of error that are considered in an uncertainty budget may include, but are not limited to: the accuracy of the instrument, a repeatability study, statistical estimation of certain parameters such as temperature uniformity or stability collected through a Design of Experiments (DOE), and/or the uncertainty of the calibration of the standard, and others. In this example, the uncertainty budget dictates that the frequency counter measurement uncertainty is ±0.05 MHz. This uncertainty has a 95% confidence interval (or at a value k=2 or 2σ), which will be described in more detail below. In FIG. 2 the measurement uncertainty is graphically displayed as a measurement uncertainty bar. In particular, the measurement uncertainty illustrates that for a measured value, or reported reading of 10 MHz, the measurement may actually be anywhere between 9.950 MHz and 10.050 MHz.

The graph of FIG. 2 also displays the test uncertainty ratio, which, as described above, is the ratio of the accuracy of the unit under test to the measurement uncertainty. The test uncertainty ratio in this example is the ratio of 0.2 MHz (the accuracy of the unit under test) to 0.05 MHz (the measurement uncertainty), or 4:1. Thus, the measurement process uncertainty is 25% of, or the measuring process is four times better than, the instrument being calibrated.

From the foregoing, the graph of FIG. 2 graphically displays to a user a significant amount of information, including the in-tolerance range for the unit under test (bounded on either end by the upper and lower tolerances), the out-of-tolerance range (the area outside the in-tolerance range), a measure of the output of the unit under test for a 10 MHz signal, the indication of the standard (STD), the uncertainty surrounding the measurement, and the test uncertainty ratio. The graph of FIG. 2 indicates that the displayed reading of the standard (i.e., measured value) is 10.000 MHz, which indicates that the UUT has no error when generating a 10 MHz signal. Moreover, because the bar representing the measurement uncertainty is contained completely within the in-tolerance region, the unit under test is considered to be in-tolerance.

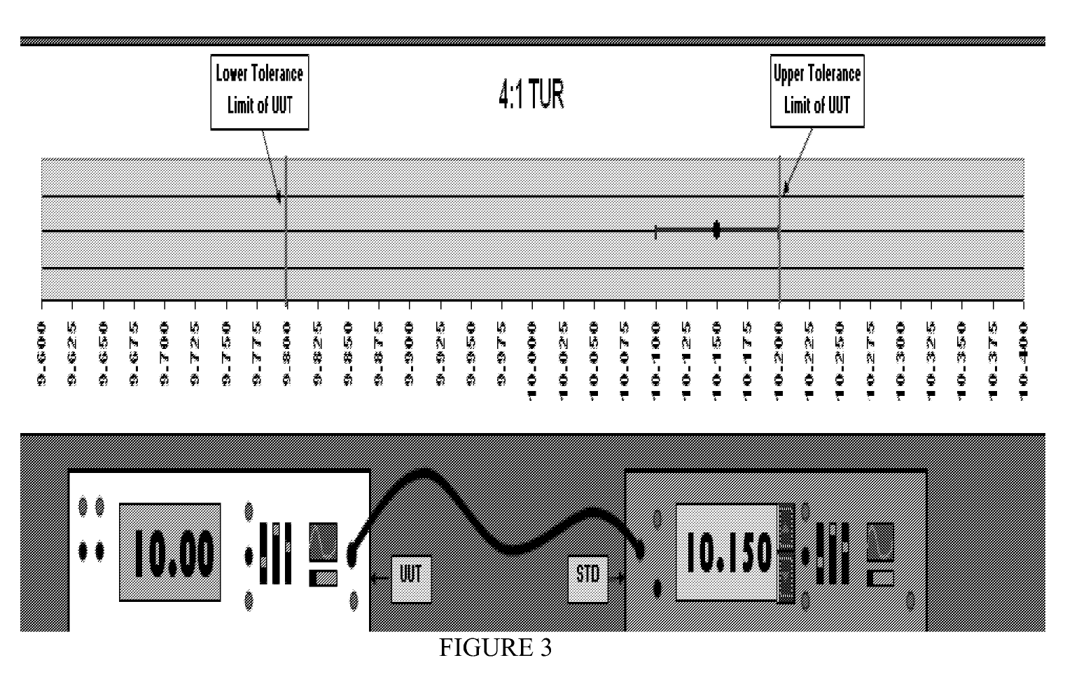

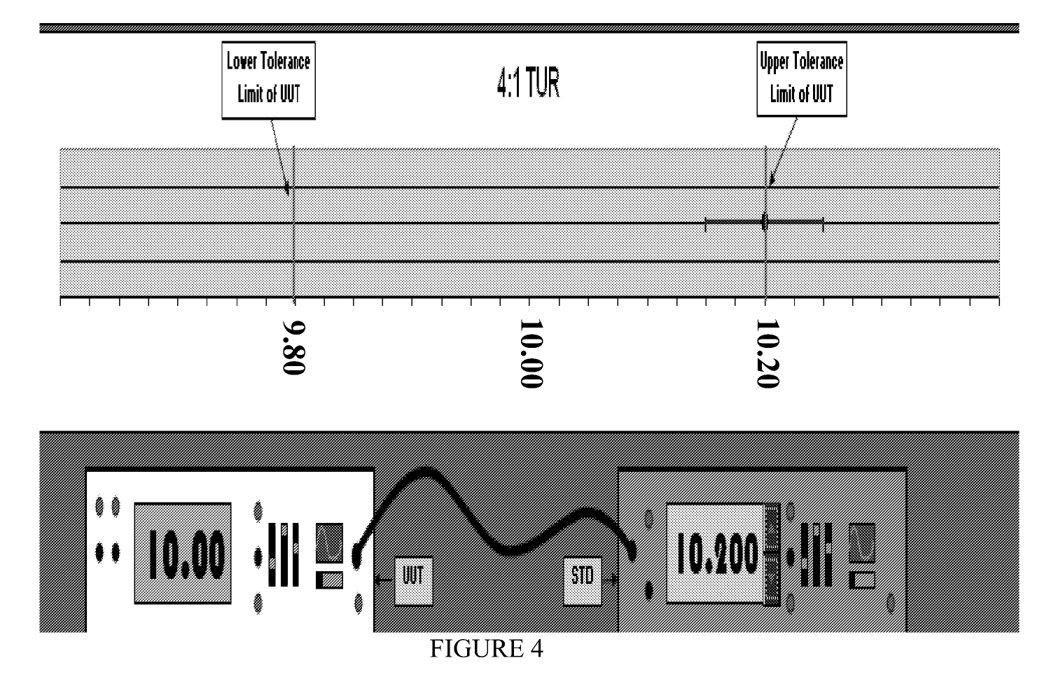

FIGS. 3 and 4 are similar to FIG. 2, but are provided to illustrate additional measured values. Specifically, FIG. 3 illustrates a scenario in which the standard indicates a measured value of 10.150 MHz. The displayed measurement uncertainty band indicates that the true value could be anywhere from 10.100 MHz to 10.200 MHz. In this example, the unit under test is considered to be in-tolerance, because the entirety of the measurement uncertainty band is within the standard's tolerance. Of course, as should be appreciated, the right end of the measurement uncertainty bar coincides directly with the upper tolerance of the unit under test. This case will be discussed in more detail below.

In FIG. 4, the standard indicates a measured value of 10.200 MHz, which coincides with the upper tolerance limit of the unit under test. As depicted by the measurement uncertainty bar, the 10.200 MHz reading may actually be anywhere between 10.150 MHz and 10.250 MHz. Thus, the unit under test may be in-tolerance or it may be out-of-tolerance, depending where along the uncertainty bar the true value lies at the moment the calibration is being performed. Without an appreciation of the concepts embodied by the uncertainty bar, as described above, the industry would consider the unit under test in FIG. 4 in-tolerance, when in fact there is essentially a 50% chance that the unit is out-of-tolerance.

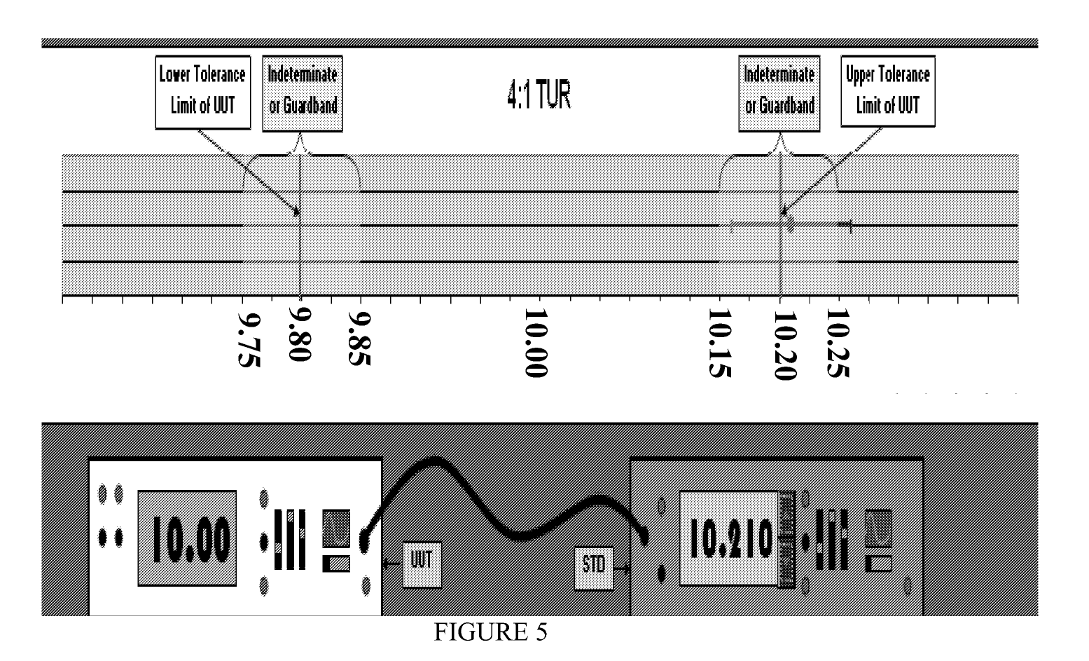

FIGS. 3 and 4 illustrate that, as the measured value approaches the upper tolerance limit, the measurement uncertainty bar informs the user that what appears to be an in-tolerance measurement may actually be an out-of-tolerance result. The same is true for measured values approaching the lower tolerance limit. In addition, if a measured value is out-of-tolerance, but is close to either the upper or lower tolerance for the unit under test, the unit under test may actually be in-tolerance. This area approaching the upper and lower tolerances is illustrated in FIG. 5 as an indeterminate, or guardband portion. Any measured value falling within the indeterminate portion may be in-tolerance, or may be out-of-tolerance. The actual value of the measurement, and therefore an absolute statement of compliance, is uncertain in this indeterminate region.

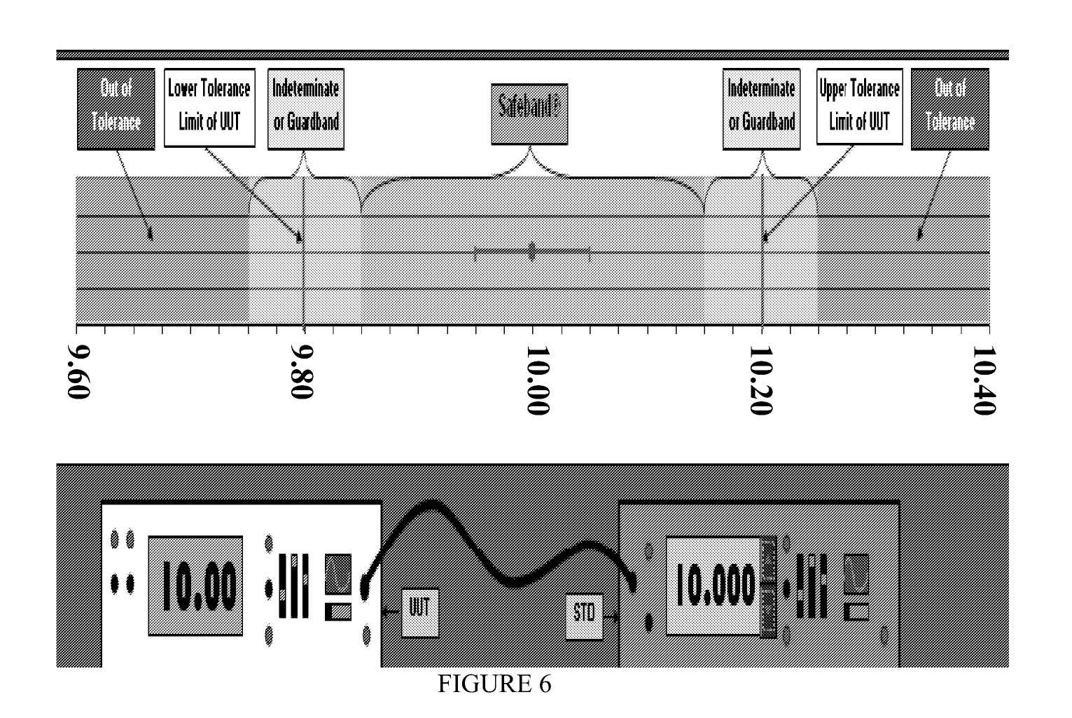

According to the foregoing, only if the measured reading falls in the area between the indeterminate regions, i.e., in the safeband, is the unit under test considered to be in-tolerance. FIG. 6 graphically illustrates the out-of-tolerance, indeterminate, and safeband areas for the unit under test in this embodiment.

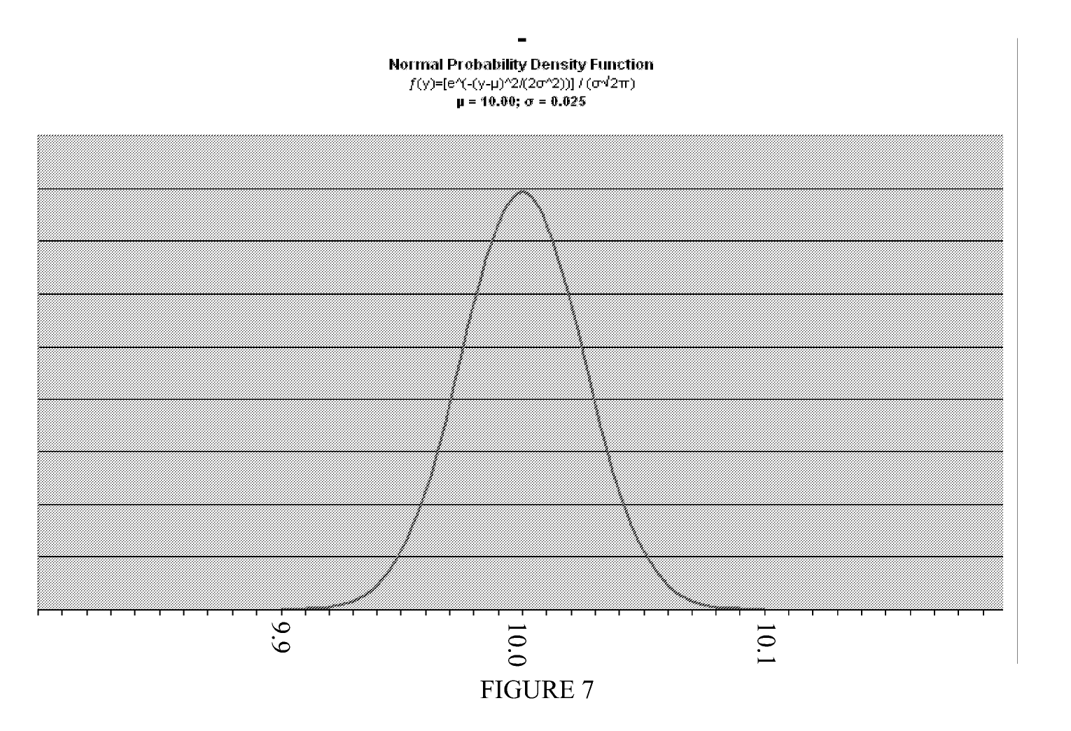

In each of the examples above, the measurement uncertainty value has an associated confidence interval of 95%. So, for example, for the measurement of FIG. 2, because the measurement has a 95% confidence interval, there is a 95% chance that the measurement of 10 MHz is anywhere between 9.950 MHz and 10.050 MHz. This confidence interval takes into account the fact that an obtained measurement will not necessarily be an absolute value of that measurement, for example, because of drift over time, or other factors. However, the measured value may be approximated as a distribution. Many distributions are known, including binomial, chi-square, gamma, Weibull, rectangular, triangular, and normal, to name a few. While some or all of these distributions may be used to characterize measurements and/or the individual components of uncertainty surrounding the measurement, the inventor has found that the combination of these uncertainty components most closely approximates a normal (or Gaussian) distribution, based on the Central Limit Theorem of probability and statistics. The normal distribution for the measurement of the 10 MHz signal according to the present embodiment is illustrated in FIG. 7.

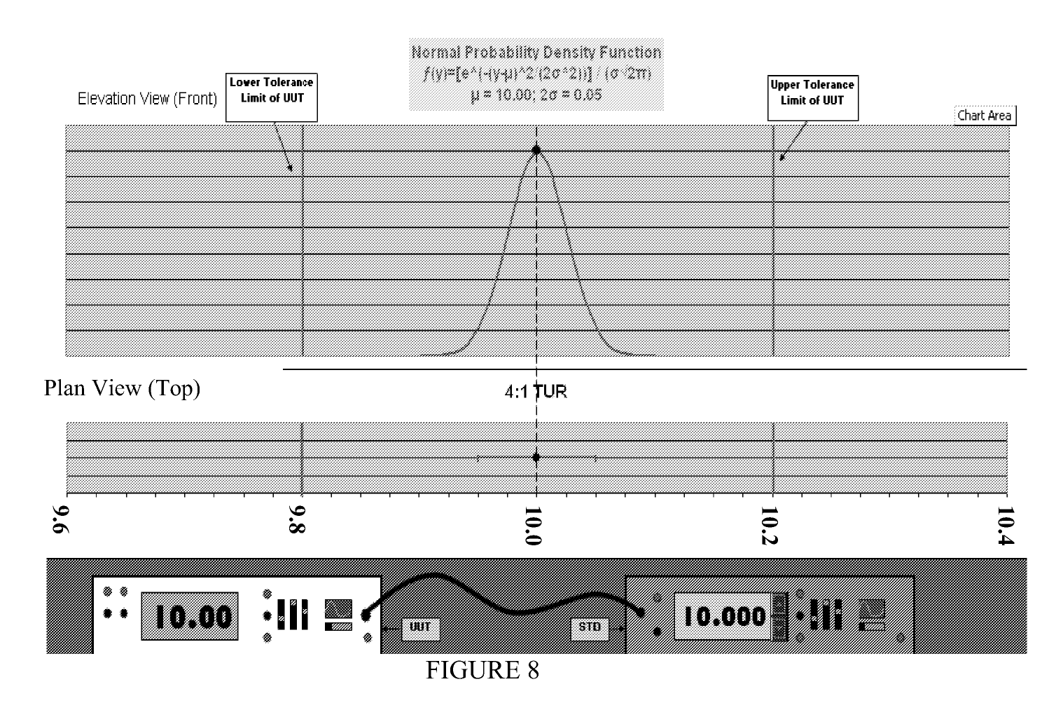

FIG. 8 illustrates a screen shot of a tool according to a preferred embodiment of the invention. In that figure, a graph is illustrated that includes the graphical depiction of FIG. 2, as well as a normal distribution representing the uncertainty of the 10 MHz measurement, as illustrated in FIG. 7. The uncertainty bar and the distribution are intended to illustrate the same concept, namely, that the measured value has an uncertainty associated with it. The inventor has found it useful to characterize the depiction using the uncertainty bar as a plan view, and to characterize the depiction using the distribution as an elevation view. Essentially, these two simultaneously displayed graphical representations are two ways of looking at the same statistical concept. FIG. 8 also includes the formula for the normal probability density function describing the uncertainty surrounding the 10 MHz measured value, for which 2σ=0.05. The reading in question is the mean value, or μ, which equals 10.00.

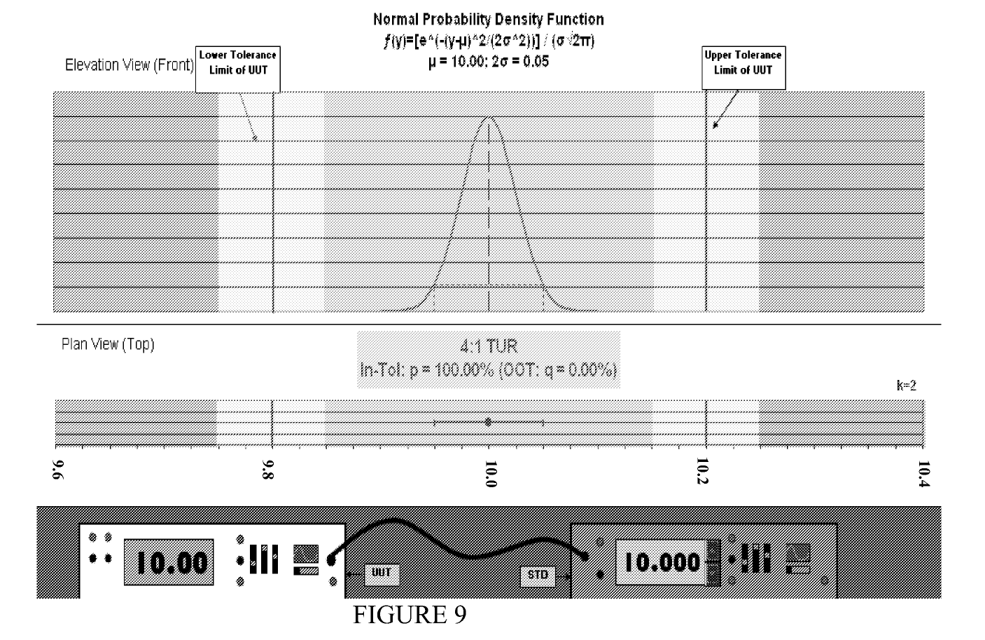

As will be appreciated from FIG. 8, the outer boundaries of the normal distribution, i.e., the upper (right) and lower (left) extremities, are further out than the upper and lower limits of the uncertainty bar included in FIG. 2 and similar graphical depictions. These boundaries are different, because the traditional graphs shown in the plan view of FIGS. 2-6 display only the 95% confidence interval, where k=2, or 2σ=0.05, while the distribution shown in the elevation view displays the “entire” distribution of the measurement, which considers all probabilistic events. FIGS. 8 and 9 illustrate this idea. Specifically, FIGS. 8 and 9 illustrate a basic rule of statistical analysis, the Empirical Rule, which says that for the illustrated normal distribution curve, the area under the distribution within ±2σ, or within ±0.05 MHz of the measured value represents 95% of the entire area under the curve. The distributions in FIGS. 8 and 9 show the entire curve, and therefore, provide a more complete illustration of what the uncertainty bar is meant to imply.

The uncertainty bar has been the traditional method used in the metrology industry to simplify graphical representations to their audience, and provides a viable tool for decision making purposes. The size of the uncertainty bar used in FIGS. 2-5 is dictated by the industry, which generally uses k=2. Of course, and as should be understood from the foregoing discussion, the uncertainty bar could be longer or shorter, depending upon the k or 2σ value used. For example, if the k value is 3, the uncertainty bar would span from 9.925 to 10.075, with a 99% confidence interval. A k value of 3.9 has a 99.9% confidence interval. Lesser k values would result in shorter uncertainty bars with lower confidence intervals, and higher k values would result in longer uncertainty bars with higher confidence intervals. For measurement reporting, no k value is better than any other k value, inasmuch as they are all different ways of describing the same normal distribution of a measured value. However, it is important that the k value, and therefore the associated confidence interval, be known and that this be related to a stated measurement uncertainty.

By standardizing at k=2, however, metrology methods that display only an uncertainty bar as shown in FIG. 2 will sometimes regard out-of-tolerance parts or processes as in-tolerance, and vice versa. FIGS. 9, 10, and 11 are used to illustrate this point.

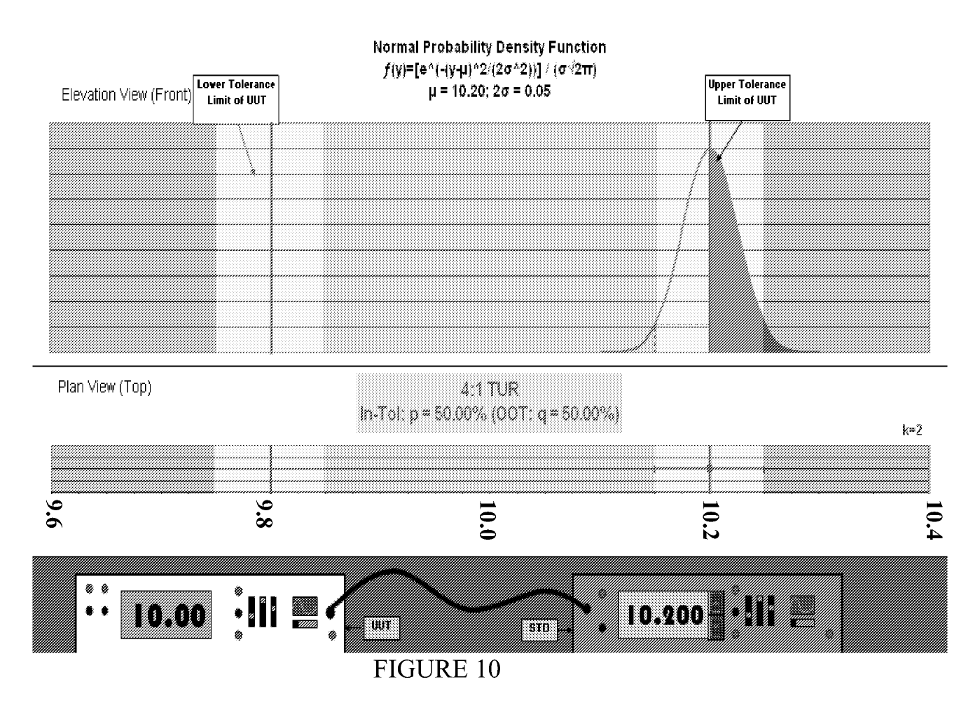

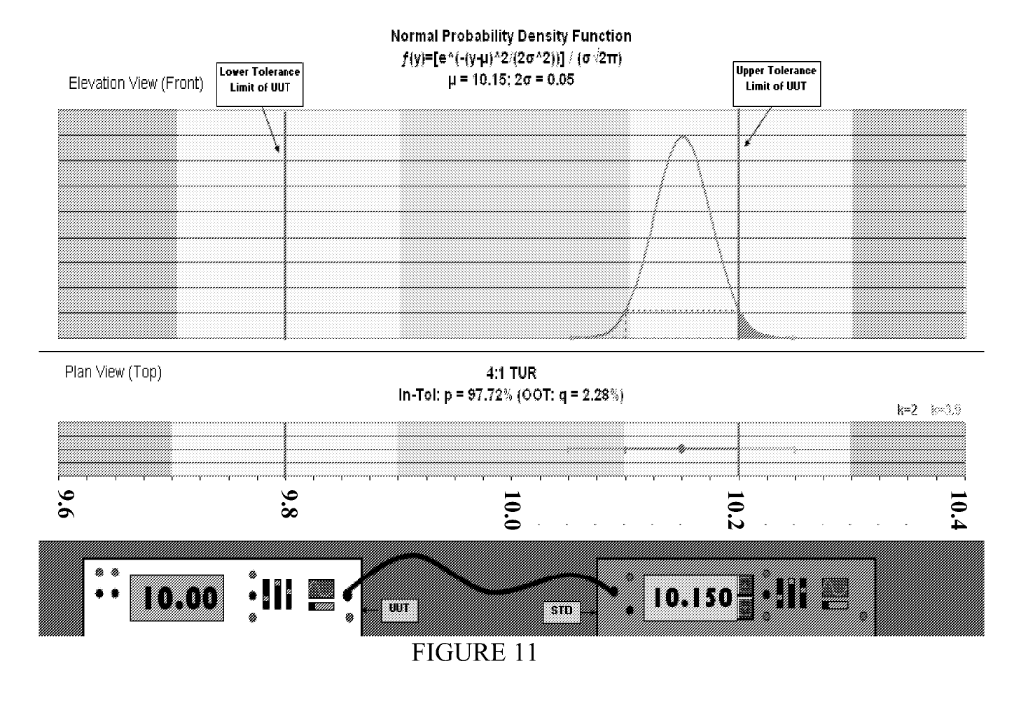

FIG. 9 depicts a screen shot according to a preferred graphical representation metrology tool which is essentially identical to that of FIG. 8. However, the display of FIG. 9 (and the displays of FIGS. 10 and 11) includes a probability expressed as a percentage that the reading is actually in-tolerance (In-Tol) and a probability expressed as a percentage that the reading is out-of-tolerance (OOT). As shown in FIG. 9, there is a 100% probability that the 10.000 MHz standard output reading is in-tolerance. This 100% probability is a result of the distribution of the 10.000 MHz measurement being entirely within the upper and lower tolerance limits for the unit under test.

FIG. 10 illustrates a graphical representation similar to FIG. 9, but in a scenario in which the standard indicates a measured value of 10.200 MHz, which is in the indeterminate region, directly coinciding with the upper tolerance limit. In this example, half of the distribution is to the right of the upper tolerance limit, and half of the distribution is to the left of the upper tolerance limit. There is a 50% probability that the unit under test is in-tolerance, and a 50% probability that the unit under test is out-of-tolerance.

A user characterizing the unit under test and having at his disposal the graphical representations of FIGS. 9 and 10 would come to the same conclusion as if he were characterizing the units based on FIGS. 2 and 4, respectively. (In fact, FIGS. 9 and 10 incorporate the graphs of FIGS. 2 and 4, respectively). Whether a user was using the graph of FIG. 9 or the graph of FIG. 2, he would readily surmise that the unit under test is in-tolerance. Similarly, whether the user was using the graph of FIG. 10 or the graph of FIG. 4, he would understand that there is a 50% chance that the measurement is in-tolerance, and a 50% probability that the measurement is out of tolerance.

However, the improved graphical methods provide additional benefit when the measurement is on the edges of, or within, the indeterminate region. In FIG. 11, for example, the standard indicates a measurement of 10.150 MHz, coincident to the left end of the indeterminate region surrounding the upper tolerance. This identical measurement was considered in FIG. 3, described above, and the FIG. 3 graph is simultaneously displayed as the “plan view” portion of the graph of FIG. 11. In FIG. 3, the right-most end of the uncertainty bar coincides with the upper tolerance, so the unit under test was considered to be in-tolerance. However, as illustrated in FIG. 11, a portion of the normal distribution of the 10.150 MHz reading is actually to the right of the upper tolerance, indicating that the unit under test may in fact be out of tolerance. Specifically, the graph of FIG. 11 indicates that there is a 97.7% chance (i.e., a probability of 0.977) that the measurement is in-tolerance and a 2.3% chance that the measurement is out-of-tolerance.

Similarly, one should appreciate that a unit under test having a measurement of 10.250 MHz would be considered out-of-tolerance under the graphing method used in FIG. 2, while the more complete graphing method of FIGS. 8-11 would indicate that there is some probability (approximately a 2.3% chance, or a probability of 0.023) that the unit under test is in-tolerance.

As is well understood in the field of statistics, the probability of the unit under test being in-tolerance can be quantified by the portion of the area under the distribution curve that lies between the upper and lower tolerance limits, expressed as a percentage of the area under the whole curve. In FIG. 9, 100% of the area under the distribution curve lies between the upper and lower tolerance limits, so there is a 100% chance that the unit under test is in-tolerance. In FIG. 10, 50% of the area under the distribution curve lies between the upper and lower tolerance limits (and 50% of the area lies to the right of the upper tolerance limit) so there is a 50% chance that the unit under test is in-tolerance. In FIG. 11, 97.7% of the area under the distribution curve lies between the upper and lower tolerance limits, so there is a 97.7% chance that the unit under test is in-tolerance.

These percentages, or areas under the graph, also may be obtained using what are known in the fields of statistics as z-scores or z-tables. In the examples of FIGS. 9-11, the distribution corresponds to k=3.9 to provide a 99.9% confidence interval, so appropriate z-scores are used.

Thus, while the graphing methods used in FIGS. 2-6 would indicate to a user that a unit under test having a measurement in the safeband was in-tolerance, that a unit under test having a measurement in the out-of-tolerance region was out-of-tolerance, and that a unit under test having a measurement in the indeterminate region may be in- or out-of-tolerance, the present invention provides a more complete graphing method. According to the improved method, when the measurement of a unit under test, including the entire distribution representing the uncertainty of the measurement, is in the safeband the unit is in-tolerance, when the measurement and its uncertainty are in the out-of-tolerance region the unit is out-of-tolerance, and when the unit under test has a measurement, including uncertainty, in the indeterminate region the probability that the actual value is in-tolerance is calculated using z-tables, and the probability is displayed on the graph.

This statement regarding probability of an in-tolerance measurement may also be referred to as a probability of compliance to the specification (or PCS). The PCS value provides the equipment user with an extra tool to assess producer and consumer risk and, ultimately, make decisions about products and processes. More specifically, in one conceivable scenario, an equipment user would recognize a PCS value of 100% as posing no risk, while a PCS value of less than 100% could suggest to the equipment user that a reverse traceability investigation to the products the unit under test was used to process may be required to minimize risk.

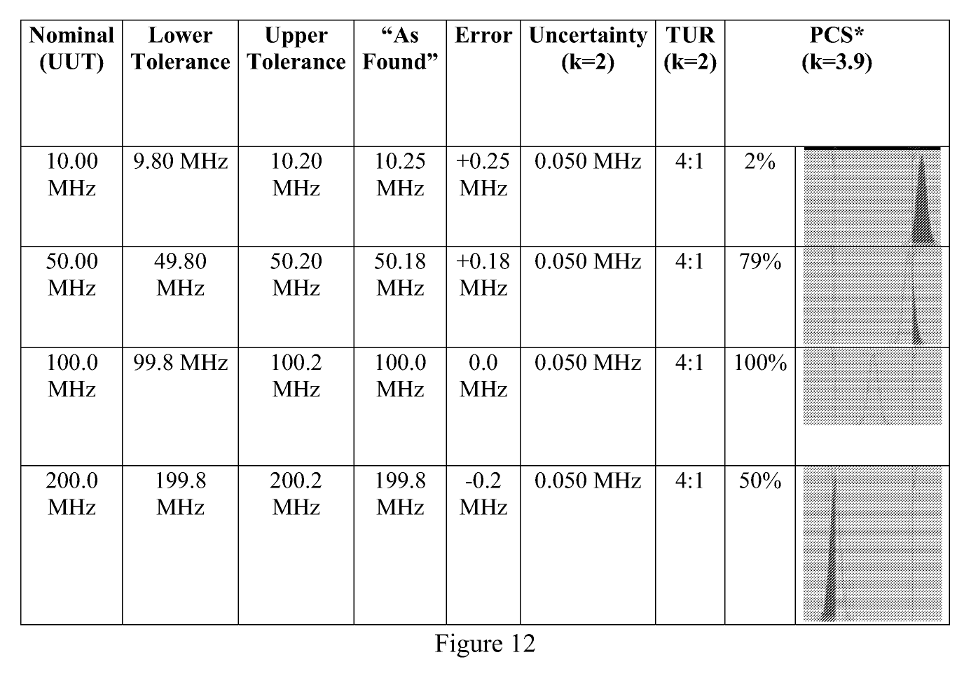

As noted above, the PCS preferably is illustrated on the graph. Alternatively, or additionally, the PCS value also may be displayed in a table or chart, along with other information about the unit under test. FIG. 12 depicts an example of a calibration report containing a number of measurements for a unit under test. As illustrated, the report includes a nominal measurement, or what the unit under test is expected to produce, in the first column. The second and third columns are the lower and upper tolerances, respectively, of the nominal measurement. The lower and upper tolerances delineate the in-tolerance zone. The fourth column is the “as found” measurement, or the measured value of the unit under test. The fifth column is the error, or difference between the as found measurement and the nominal measurement. The uncertainty in the as found reading is expressed in the sixth column, and the seventh column contains the test uncertainty ratio. The final column contains the PCS value (expressed as a percentage) and a graph providing visual indication of the PCS, with the out-of-tolerance portion of the measurement shaded. Preferably, for ease of use, the tool according to the invention provides differently colored shading to designate, e.g., in-tolerance and out-of-tolerance portions of the distribution. In one preferred embodiment, the in-tolerance portion is shaded in green and the out-of-tolerance portion is shaded in red. Of course, other or no colors may be alternatively used, and may be even be specified by the user.

In FIG. 12, the uncertainty and test uncertainty ratio are reported for k=2, while the PCS value is expressed for k=3.9. In this preferred embodiment, k=2 is used for the uncertainty and test uncertainty ratio merely because this has been an industry standard. These values could be calculated (and reported) for k=3.9, or for any k value, without departing from the scope of the invention.

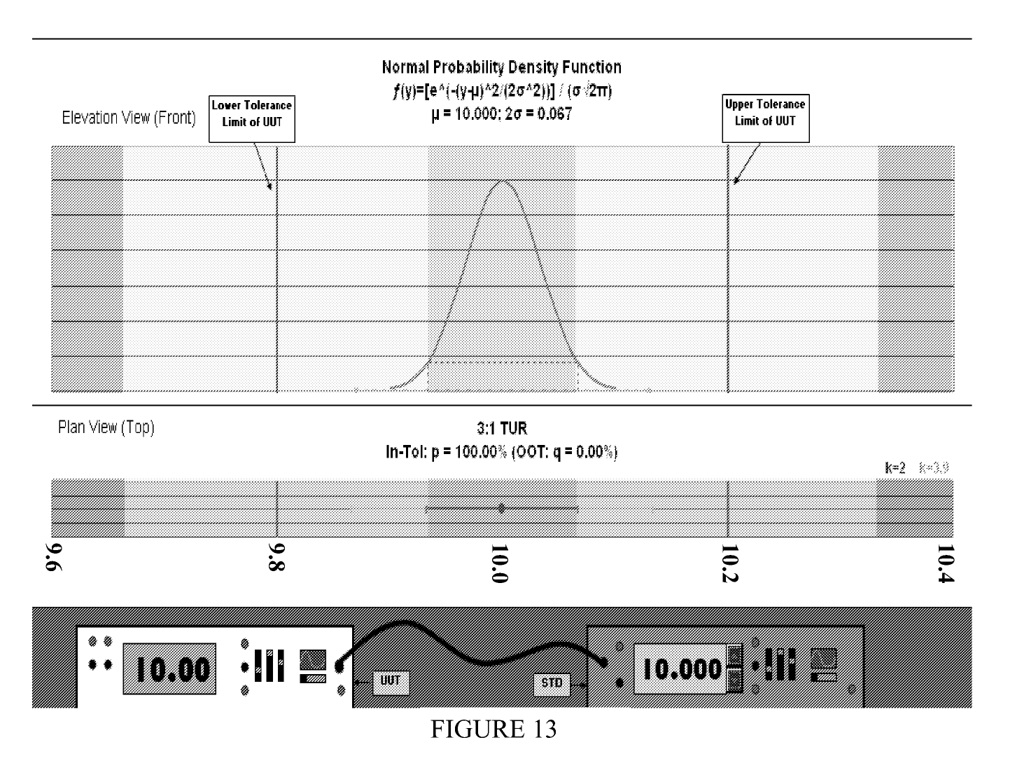

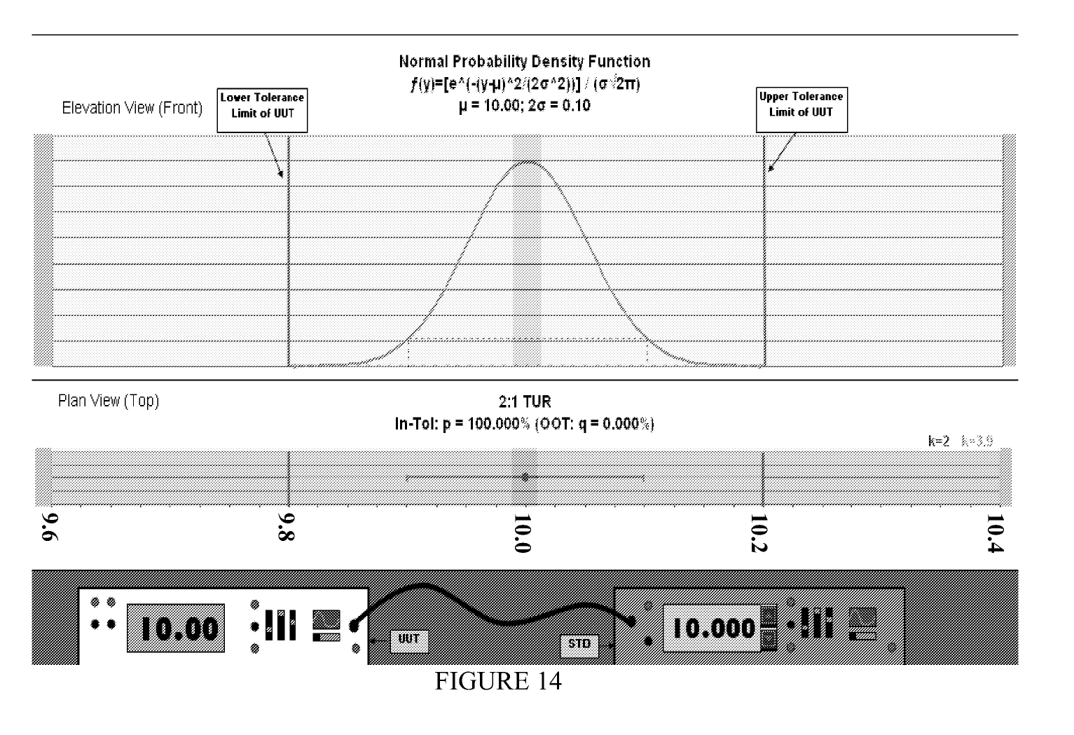

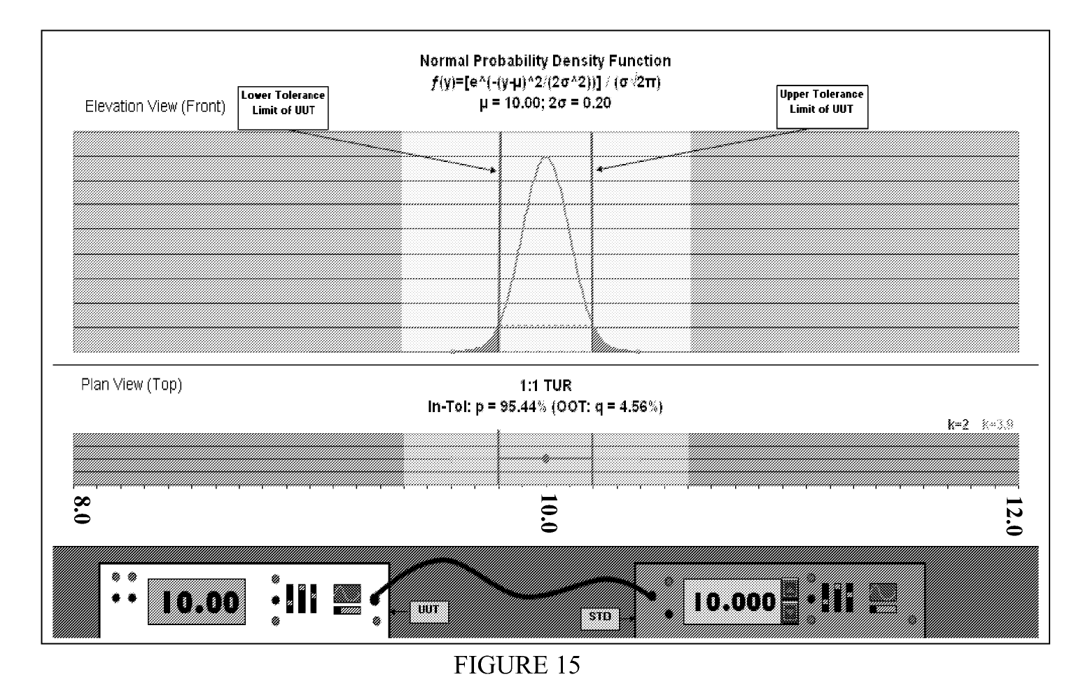

While the examples to this point have centered on a test uncertainty ratio of 4:1, the present invention is also extremely useful for other test uncertainty ratios. Lower test uncertainty ratios result in larger indeterminate bands and smaller safebands. In particular, more uncertainty is the cause of lower test uncertainty ratios, so the normal distribution of measurements having greater uncertainty is a larger, or wider curve, in which the upper and lower values of the curve at k=3.9 are farther apart. FIG. 13 illustrates a scenario in which the test uncertainty ratio is 3:1 and FIG. 14 illustrates a scenario in which the test uncertainty ratio is 2:1. As depicted in FIG. 14, only an “as found” measurement (or measured value) of nominal will be in the safeband, and every other measurement has some associated risk of resulting in an out of tolerance condition. As should be appreciated, even smaller test uncertainty ratios, for example, 1:1, as illustrated in FIG. 15, provide further interesting results. In the scenario of FIG. 15, there is no safeband, and even a nominal reading has some risk of resulting in an out of tolerance condition, as illustrated by both ends of the distribution being beyond the tolerance regions. Under the graphing method of FIGS. 2-6, a nominal measurement for a test uncertainty ratio of 1:1 would be in-tolerance, although the inventor has found and graphically displayed that there is actually some probability that the unit is out-of-tolerance.

The PCS value more completely describes a unit under test. More specifically, the PCS value will indicate to a quality engineer or the like not only a reading, but the probability that the reading is in compliance with the specification.

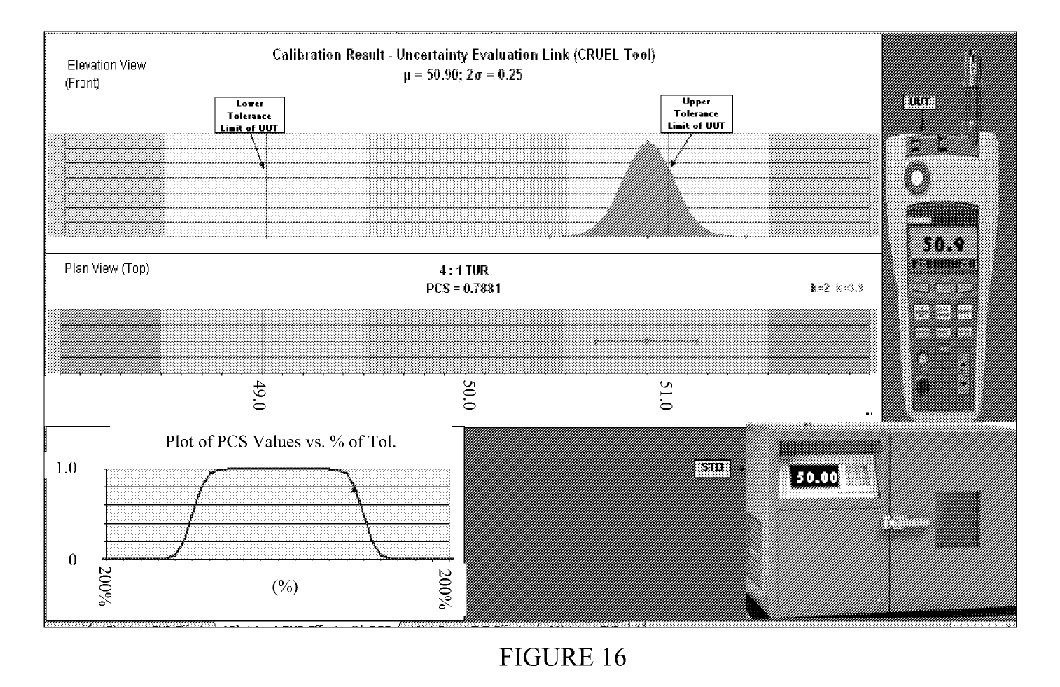

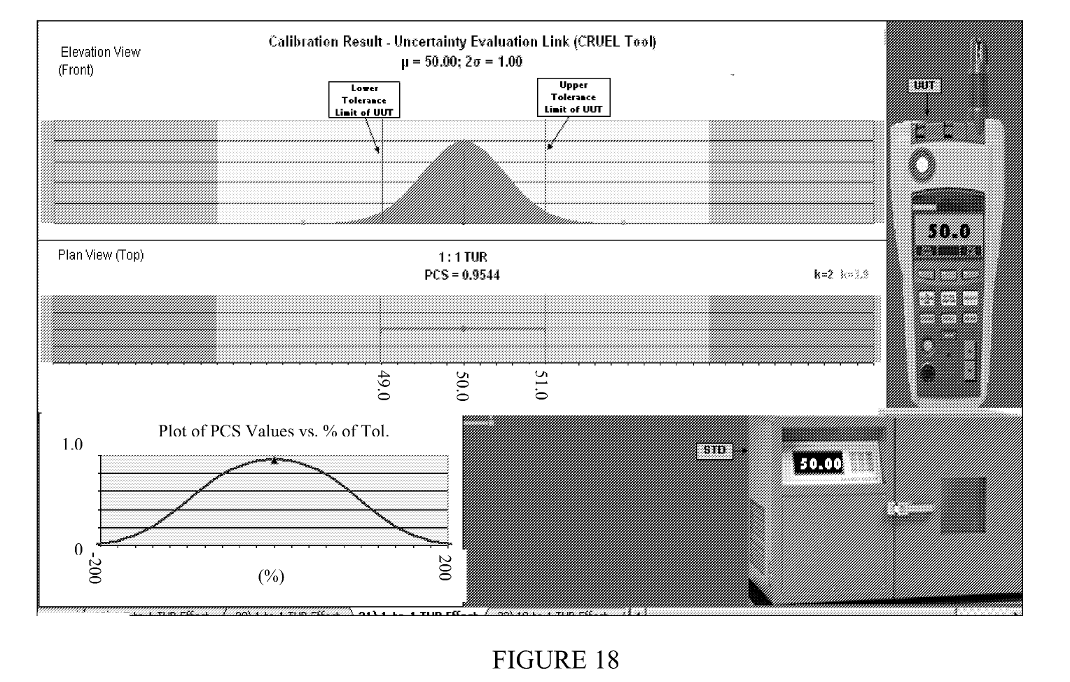

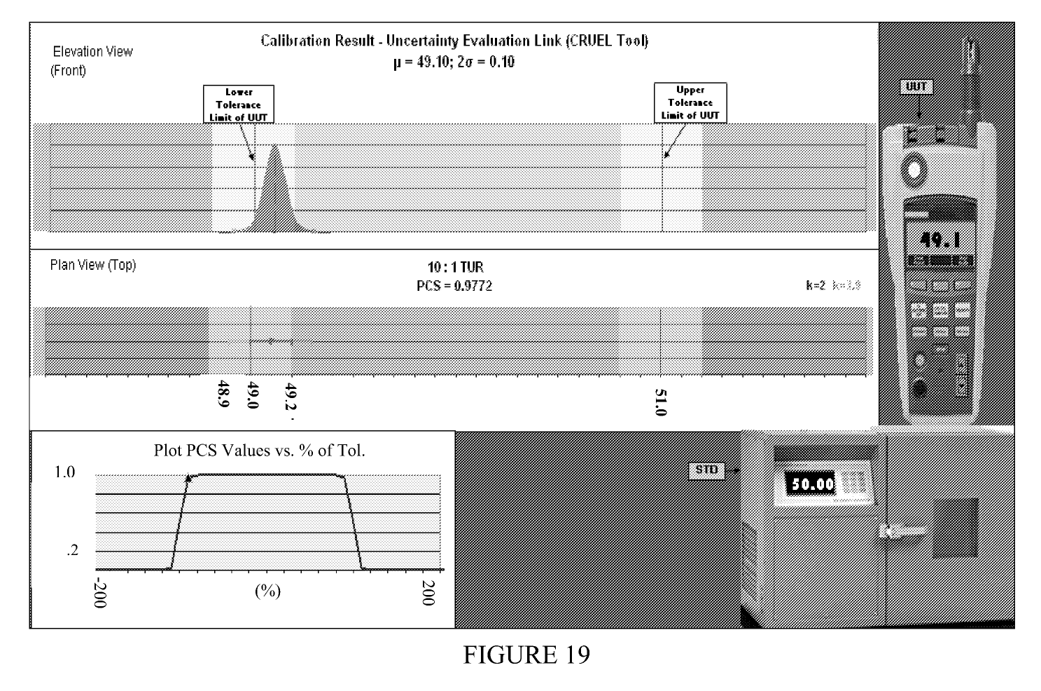

FIGS. 16-19 illustrate screen shots of another tool embodying the present invention. In these figures, the unit under test is a humidity measuring instrument. In FIG. 16, for example, the expected readout is 50.000% RH (relative humidity) and the accuracy is ±1.000%. Accordingly, the upper tolerance is 51.000% RH and the lower tolerance is 49.000% RH. The measured reading for the unit under test is 50.9% RH, which is plotted along with its associated uncertainty, as in the embodiments and Figures described above. Also like the previous embodiments, the test uncertainty ratio and the PCS value are provided on the depiction. Unlike the previous examples, the graphical representation of FIG. 16 also includes a graph plotting the PCS values against the percent of the tolerance. The measured value is indicated on the graph to provide the user with another tool for assessing the risk associated with the measurement. Instead of the percent of tolerance, the PCS values could alternatively be plotted against the measured values, i.e., values from 48.000% RH to 52.000% RH.

As also illustrated in FIG. 16, a graphical representation according the present invention also may include a representation of the unit under test (a representation of the humidity measuring instrument in FIG. 16-19). For example, the preferred metrology tool may be used with a number of different instruments (units under test) from a number of different manufacturers. The user of the tool selects the appropriate instrument, or unit under test, from a pre-stored number of instruments with which the tool may be used. A graphical representation of the selected instrument may then be displayed as a visual check for the user. The tool according to the invention preferably also stores for each of the instruments the OEM specifications, which can include the tolerances for the instrument at given measurements. In this manner, the user does not need to re-enter tolerances and other similar data each time a similar instrument is tested.

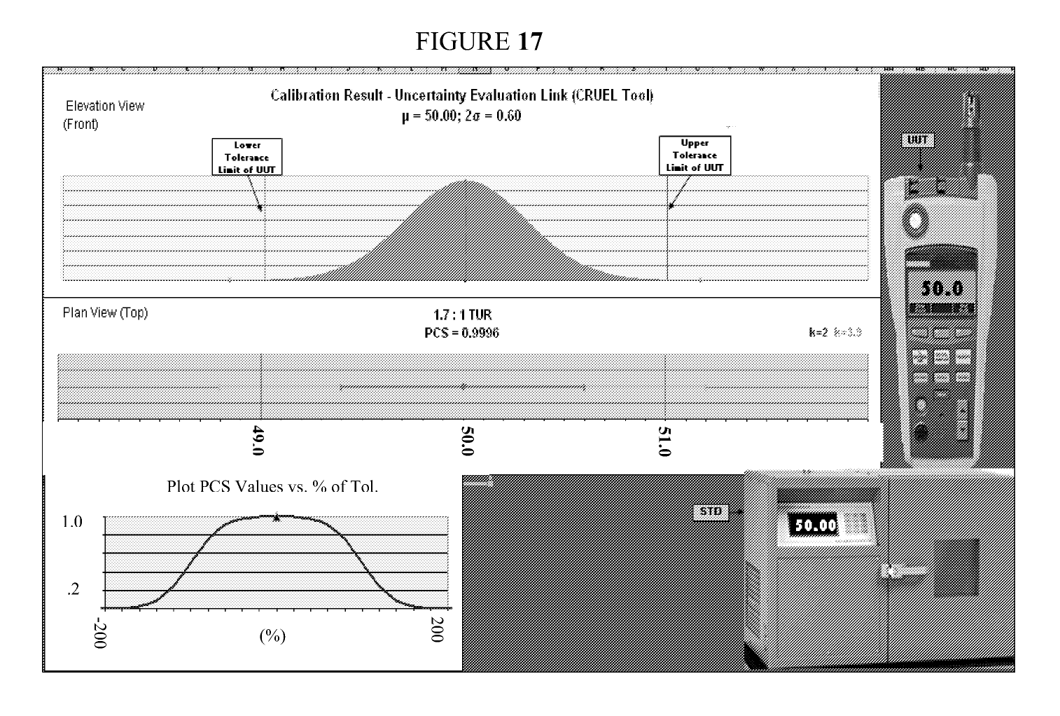

FIGS. 17-19 are additional graphical depictions according to the invention similar to the depiction of FIG. 16. Each of these embodiments illustrates results for units having different test uncertainty ratios.

As described above, the present invention provides metrology methods and a metrology tool that provide an equipment user with more sophisticated information about a measurement. This information is particularly helpful for risk-assessment purposes by both producers and consumers. The invention may be embodied in a tool in communication with one or both of the unit under test and the calibration equipment. The methods disclosed preferably are implemented on a personal computer or other computing device and may be stored on any computer readable medium. Alternatively, the calibration equipment or the unit under test could include software, hardware, or the like for performing the methods according to the invention. More specifically, the graphical representations of the preferred embodiments could be displayed on a display incorporated in the calibration equipment or the unit under test.

The foregoing embodiments of the invention are representative embodiments, and are provided for illustrative purposes. The embodiments are not intended to limit the scope of the invention. Variations and modifications are apparent from a reading of the preceding description and are included within the scope of the invention. The invention is intended to be limited only by the scope of the accompanying claims.

I claim:

1. A metrology method, comprising:
determining a probability of compliance to a specification of a measured value based on the measured value, an associated uncertainty of the measured value and a predetermined target value.

2. The metrology method of claim 1, further comprising displaying the probability of compliance, the measured value, the associated uncertainty and the predetermined target value.

3. The metrology method of claim 1 wherein the predetermined value has an associated tolerance.

4. The metrology method of claim 1, further comprising the steps of:
displaying the probability of compliance on a graph; and
graphically displaying on the graph the measured value, the associated uncertainty of the measured value, the predetermined target value, and a tolerance associated with the predetermined target value.

5. The metrology method of claim 4, wherein the measured value and associated uncertainty of the measured value are graphically displayed as a distribution.

6. The metrology method of claim 5, wherein the distribution is a normal distribution.

7. The metrology method of claim 4, wherein the tolerance associated with the predetermined target value comprises an upper tolerance and a lower tolerance, and wherein an area bounded by the upper tolerance and the lower tolerance is an in-tolerance area.

8. The metrology method of claim 7, further comprising illustrating on the graph a pair of indeterminate bands, a first of the pair of bands having a center corresponding to the upper tolerance and the second of the pair of bands having a center corresponding to the lower tolerance, an area between the pair of bands comprising a safe band.

9. A method of displaying results to a user comprising the steps of:
graphically representing a target calibration amount and a tolerance associated with the target calibration on a graph;
obtaining a reported reading of an instrument to be tested;
graphically representing the reported reading on the graph with an uncertainty associated with the reported reading; and
displaying a probability of compliance of the reported reading to the target calibration amount and associated tolerance.

10. The method of claim 9 wherein the associated uncertainty comprises a measurement uncertainty at a predetermined confidence interval.

11. The method of claim 9 wherein the predetermined confidence interval is 95%.

12. The method of claim 9, wherein the predetermined confidence interval is 99.9%.

13. The method of claim 9, wherein the associated uncertainty is displayed as one or both of a measurement uncertainty bar and a distribution of the measured value.

14. The method of claim 13, wherein the measurement uncertainty bar has a first associated predetermined confidence interval and the distribution of the measured value has a second associated predetermined confidence interval.

15. The method of claim 10, wherein the measurement uncertainty comprises an accuracy of a standard measurement.

16. The method of claim 10, wherein the associated uncertainty is an uncertainty of a process used to obtain the reported reading.

17. The method of claim 9 further comprising the step of displaying on the graph a ratio between the tolerance associated with the calibration amount and the uncertainty associated with the reported reading.

18. The method of claim 9, wherein the probability of compliance is a percentage between 0% and 100%, inclusive.

19. The method of claim 9, wherein the tolerance associated with the target calibration comprises an upper tolerance, which is equal to the sum of the target calibration amount and a positive portion of an accuracy specification, and a lower tolerance, which is equal to the sum of the target calibration amount and a negative portion of the accuracy specification.

20. The method of claim 19, wherein the graphical depiction of the target calibration amount and associated tolerance comprises a band of one or more in-tolerance values bounded on opposite sides by the upper tolerance and the lower tolerance.

21. The method of claim 20, further comprising illustrating on the graph a pair of indeterminate bands, a first of the pair of bands having a center corresponding to the upper tolerance and the second of the pair of bands having a center corresponding to the lower tolerance.

22. The method of claim 21, wherein when the reported reading is within either of the pair of indeterminate bands, the PCS is greater than 0% and less than 100%.

23. The method of claim 21, further comprising the step of illustrating on the graph a safe band between the indeterminate bands.

24. The method of claim 23, wherein when the reported reading falls within the safe band, the PCS is 100%.

25. The method of claim 23, wherein when the reported reading is in neither the intermediate bands nor in the safe band, the PCS is 0%, and the unit under test is out of tolerance.

26. The method of claim 9, wherein the graphical representation of the reported reading and the uncertainty associated with the reported reading is a distribution.

27. The method of claim 26, wherein the distribution is a normal distribution.

28. The method of claim 9, further comprising the step of graphically representing the probability of compliance to the specification for measurements other than the reported reading.

29. The method of claim 28, wherein the graphical representation of the probability of compliance to the specification for measurements other than the reported reading is a plot of PCS values of measurements versus a percentage of the instrument's tolerance.

30. The method of claim 9, further comprising the step of displaying a representation of the unit under test.

31. A method of graphing measurements comprising:
assigning a two-dimensional graphic to a measured value;
comparing the two-dimensional graphic to a specification having predetermined upper and lower tolerances; and
identifying a probability of compliance of the measured value to the specification.

32. The method of claim 31, wherein the two-dimensional graphic is a distribution associated with the measured value.

33. The method of claim 32, wherein the distribution is a normal distribution.

34. The method of claim 33, wherein the probability of compliance corresponds to a z-value associated with the graphical position of intersection between the normal distribution of the measured value and at least one of the predetermined upper and lower tolerances.

35. A method of displaying results to a user comprising the steps of:
providing on a graph a target measurement and upper and lower tolerances of the target measurement;
graphically representing on the graph a reported reading of a tested instrument;
graphically displaying a measurement uncertainty associated with the reported reading; and
determining and displaying on the graph a probability of compliance of the reported reading to the target measurement value.

36. The method of claim 35 further comprising the step of:
establishing a decision rule based on the probability of compliance.

37. The method of claim 35 further comprising the step of:
displaying a graphical representation of the tested instrument.
